(19) United States
(12) Patent Application Publication
(10) Pub. No.: US 2010/0067343 A1
(43) Pub. Date: Mar. 18, 2010

(54) Information Processing Apparatus, Health Check Method, and Storage Medium

(75) Inventor: Yoshihiro Kaneko, Fussa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/478,636

(22) Filed: Jun. 4, 2009

(30) Foreign Application Priority Data
Sep. 18, 2008 (JP) 2008-239981

(51) Int. Cl. G11B 27/36

(52) U.S. Cl. 369/53.44; G9B/27.052

(57) ABSTRACT

According to one embodiment, an information processing apparatus includes an optical disk drive, a power supply module configured to supply power to the information processing apparatus, an acquisition module configured to start acquisition of status information of the optical disk drive when the power supply module supplies power to the information processing apparatus, a storage module configured to store feedback information corresponding to each condition predetermined for the status information of the optical disk drive, and a notification module configured to notify the apparatus of feedback information which is read from the storage module in correspondence with the condition when the status information of the optical disk drive acquired by the acquisition module matches the condition.

### CROSS-REFERENCE TO RELATED APPLICATIONS

This application is based upon and claims the benefit of priority from Japanese Patent Application No. 2008-239981, filed Sep. 18, 2008, the entire contents of which are incorporated herein by reference.

### BACKGROUND

1. Field

One embodiment of the present invention relates to an information processing apparatus having an optical disk drive health check function and, more particularly, to an information processing apparatus, health check method, and storage medium capable of sending health check information from an optical disk drive to a computer.

2. Description of the Related Art

An unexpected failure in a device such as a computer that is, e.g., being used by a user is generally detrimental to the convenience of the user. Especially, a failure in an optical disk drive may impede software installation or playback of content stored in the optical disk drive. To predict such a failure in a computer, for example, Jpn. Pat. Appln. KOKAI Publication No. 2007-241384 discloses a technique of acquiring a time necessary for data access and the state of each device and determining a failure factor.

However, the technique disclosed in Jpn. Pat. Appln. KOKAI Publication No. 2007-241384 only determines a failure in a specific device mounted in a computer simply based on deterioration in the quality of the device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus according to an embodiment of the present invention;

FIG. 2 is an exemplary block diagram showing the main arrangement of the information processing apparatus according to the embodiment;

FIG. 3 is an exemplary flowchart for explaining a health check method using the information processing apparatus according to the embodiment and an optical disk drive, and processing of a program;

FIG. 4 is an exemplary view schematically table information used in the information processing apparatus according to the embodiment; and

FIG. 5 is an exemplary view schematically table information used in the information processing apparatus according to the embodiment.

### DETAILED DESCRIPTION

Various embodiments according to the invention will be described hereinafter with reference to the accompanying drawings. In general, according to one embodiment of the invention, an information processing apparatus includes: an optical disk drive; a power supply module configured to supply power to the information processing apparatus; an acquisition module configured to start acquisition of status information of said optical disk drive when said power supply module supplies power to the information processing apparatus; a storage module configured to store feedback information corresponding to each condition predetermined for the status information of said optical disk drive; and a notification module configured to notify the apparatus of feedback information which is read from said storage module in correspondence with the condition when the status information of said optical disk drive acquired by said acquisition module matches the condition.

An embodiment of the present invention will now be described with reference to the accompanying drawing.

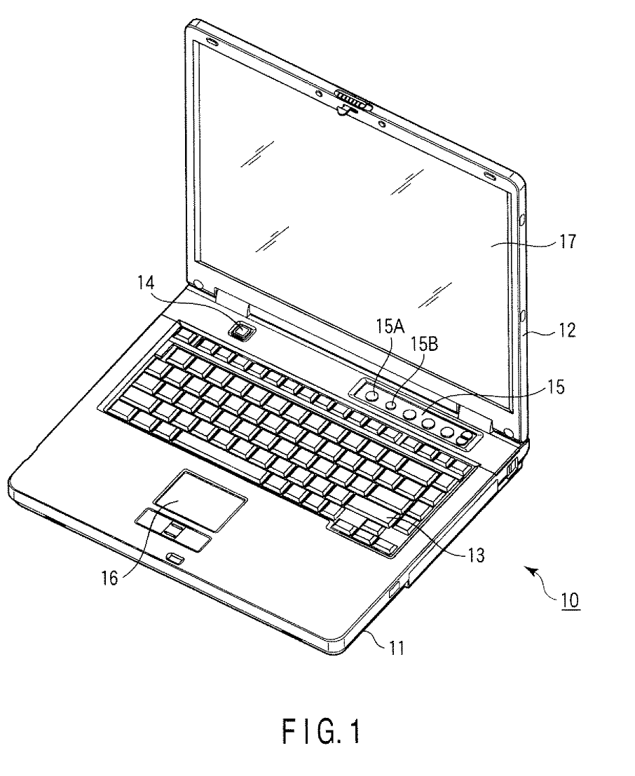

The arrangement of an information processing apparatus according to an embodiment of the present invention will be described with reference to FIG. 1. Health check indicates here defining the state of an optical disk drive in a personal computer, which is operating as intended, as a health state, checking the degree of health of the operation of the computer, and notifying the computer of the health state as needed (feedback). The information processing apparatus also has a function of obtaining a health state based on information about the daily operation state of each personal computer and checking whether the optical disk drive of a computer shows a sign of, e.g., a failure.

The information processing apparatus is implemented as, e.g., a notebook personal computer 10.

FIG. 1 is a perspective view showing a state in which the display unit of the notebook personal computer 10 is open. The computer 10 includes a computer main body 11, and a display unit 12. The display unit 12 incorporates a display device formed from a liquid crystal display (LCD) display unit 17. The display screen of the LCD 17 is located almost at the center of the display unit 12.

The display unit 12 can freely pivot between an open position and a close position with respect to the computer main body 11. The computer main body 11 has a thin box-shaped case. A power button 14 to power on/off the computer 10, an input operation panel 15, a touch pad 16, a power supply controller 123, and a power supply circuit (power supply module) 126 are arranged on the upper surface of the computer main body 11. An optical disk drive (ODD) 122 is arranged on a side surface of the computer main body 11.

The input operation panel 15 is an input device which inputs an event corresponding to a pressed button to the system, and includes a plurality of buttons to activate a plurality of functions. The buttons include a TV activation button 15A and a Digital Versatile Disc (DVD) activation button 15B. The TV activation button 15A is a button to activate a TV function of playing back or recording broadcasting program data such as a digital TV broadcasting program. When the user presses the TV activation button 15A, a TV application program to execute the TV function is activated. The DVD activation button 15B is a button to play back video content recorded on a DVD. When the user presses the DVD activation button 15B, an application program to play back video content is automatically activated.

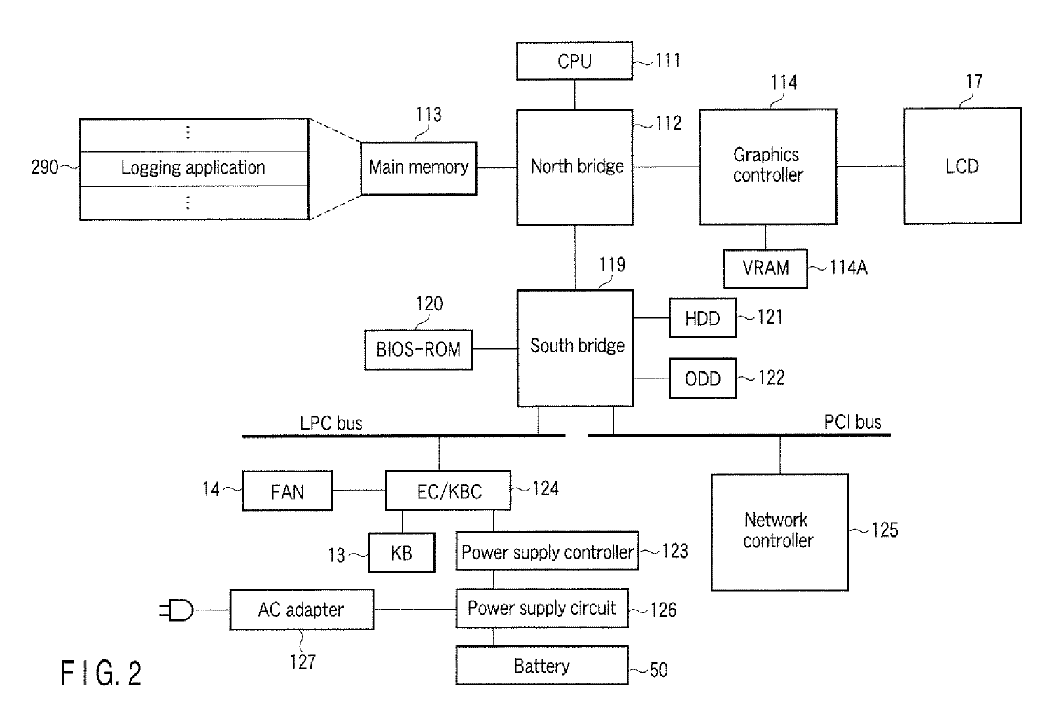

FIG. 2 is a block diagram showing the main arrangement of the client computer 10.

The computer 10 includes a CPU 111, north bridge 112, main memory 113, graphics controller 114, south bridge 119, BIOS-ROM 120, hard disk drive (HDD) 121, optical disk drive (ODD) 122, embedded controller/keyboard controller IC (EC/KBC) 124, fan 14, power supply controller 123, power supply circuit 126, battery 50, AC adapter 127, and network controller 125. Note that the optical disk drive 122 has a function (to be described later) of notifying the computer 10 of an error that has occurred in the optical disk drive 122.

The CPU 111 is a processor provided to control the operation of the computer 10 and executes an operating system and various applications such as a logging application (acquisition module and notification module) 290, which are loaded from the HDD 121 to the memory 113.

The logging application 290 monitors the operation state of the above-described optical disk drive 122 and stores it as the status information of the optical disk drive 122 in, e.g., the HDD 121. When monitoring the operation state of the optical disk drive 122, for example, the logging application 290 acquires the temperature of the optical disk drive 122, the operation time of each part of the optical disk drive 122, the eccentricity information of the rotating shaft of the optical disk drive 122, the mass eccentricity information of the rotating shaft of the optical disk drive 122, the wobbling information of the rotating plane of the optical disk drive 122, the output value information of the laser diode of the optical disk drive 122 (the current supplied to the laser diode), the light emission accumulation time (read/write) of the laser diode, the drive information (vender information, model, and firmware revision), the information of each disk inserted in the optical disk drive 122 (disk type, medium vender, and use frequency), the information of operation commands for the optical disk drive 122 (all commands including read, write, and formatting), the response time of each command for the optical disk drive 122, detailed data stored upon occurrence of command errors, the read/write transfer time of the optical disk drive 122, the transfer rates of the optical disk drive 122 and media (whether the transfer rates match the specifications of the optical disk drive 122 and media), command execution programs (programs which have executed read, write, and formatting), information acquirable from the transfer rates of the optical disk drive 122 and media (e.g., volatile information), the rotation time of the spindle motor, the on/off count of the spindle motor, the seek time, the eject/load time, and the drive retry count (read/write). Note that the logging application 290 can acquire not only the pieces of information described above but also various kinds of operation state information of the optical disk drive 122.

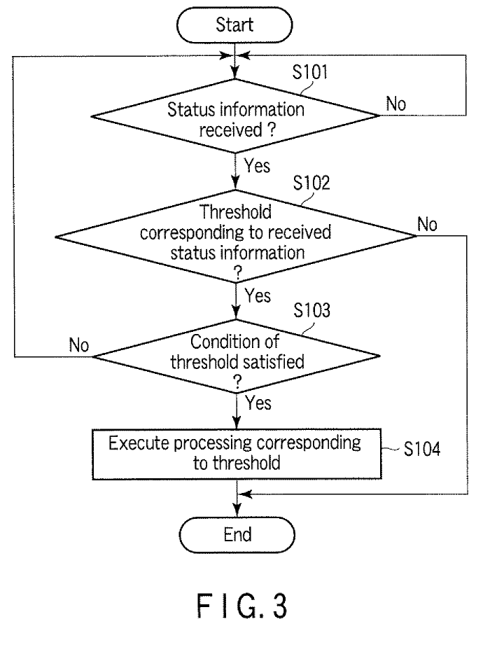

A health check method using the information processing apparatus according to the present invention having the above-described arrangement and processing of a program will be described with reference to the flowchart in FIG. 3.

First, upon activating the computer 10, activation of the logging application 290 (failure sign application) starts. More specifically, the CPU 111 of the computer 10 loads the logging application 290 to the memory 113. The logging application 290 controlled by the CPU 111 performs logging (monitoring and storing) of status information representing the operation state of the optical disk drive 122 of the computer 10 (the logging application 290 notifies the optical disk drive 122 of a mode to acquire the status information of the optical disk drive 122, as needed).

The logging application 290 determines whether the status information of the optical disk drive 122 is received (block S101). The status information of the optical disk drive 122 includes error information received from the optical disk drive 122, the temperature of the optical disk drive 122, the operation time of each part of the optical disk drive 122, the eccentricity information of the rotating shaft of the optical disk drive 122, the mass eccentricity information of the rotating shaft of the optical disk drive 122, the wobbling information of the rotating plane of the optical disk drive 122, and the output value information of the laser diode of the optical disk drive 122.

Upon determining in block S101 that the status information of the optical disk drive 122 is received (YES in block S101), the logging application 290 stores the received status information in, e.g., the HDD 121 of the computer 10.

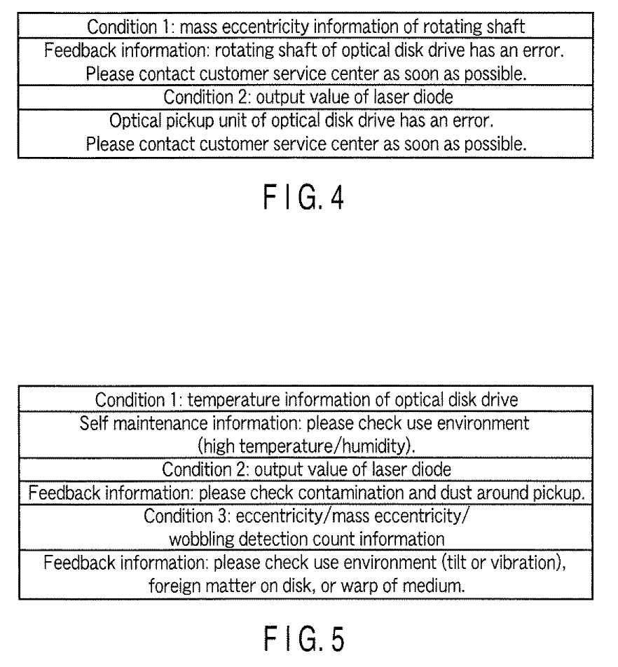

In block S102, the logging application 290 determines whether a threshold corresponding to a piece of received status information exists. Upon determining that a threshold corresponding to a piece of received status information exists (YES in block S102), and also determining that the condition of the threshold is satisfied (YES in block S103), processing corresponding to the threshold is executed (block S104). For example, as shown in FIG. 4, if a threshold corresponding to the mass eccentricity information (status information) of the rotating shaft of the optical disk drive 122 has reached a predetermined value, corresponding feedback information (table information) is read from, e.g., the HDD 121. For example, a message “the rotating shaft of the optical disk drive 122 has an error. Please contact the customer service center as soon as possible” is displayed on the display of the computer 10, thereby notifying the user.

Otherwise, as shown in FIG. 4, if a threshold corresponding to the output value information (status information) of the laser diode of the optical disk drive 122 has reached a predetermined value, corresponding feedback information is read from, e.g., the HDD 121. For example, a message “the optical pickup of the optical disk drive 122 has an error. Please contact the customer service center as soon as possible” is displayed on the display of the computer 10, thereby notifying the user.

When acquiring the above-described status information of the optical disk drive 122, for example, a filter driver monitors an AT Attachment Packet Interface (ATAPI) command which is sent to the drive and executed by a writing application (application which performs write on a DVD-R or the like) or DVD player application used in the optical disk drive 122, and stores it as use log or frequency information in the management area of, e.g., the HDD 121. During monitoring the ATAPI command, an error code transmitted from the optical disk drive 122 for the command is monitored, and the error information of the optical disk drive 122 is stored in the management area of the HDD 121. Each data from the optical disk drive 122 is acquired by periodically sending a dedicated command for, e.g., the vender to the optical disk drive 122. Similarly, each information acquired from the optical disk drive 122 is stored in the management area of the HDD 121. The information acquirable from the optical disk drive 122 is volatile. Hence, the optical disk drive 122 is powered off when the computer 10 is shut down or shifts to a standby mode or hibernation mode. For this reason, the status information of the optical disk drive 122 during activation of the computer 10 is lost. To prevent this, upon detecting a shutdown, standby, or hibernation request from the computer 10, the logging application 290 receives the acquirable information (including the error information of the optical disk drive 122) stored in, e.g., a cache provided in the optical disk drive 122 and stores it in the management area of the HDD 121.

The failure diagnosis and the prediction method can also take the following forms. More specifically, the frequency of access to the optical disk drive 122 is acquired by time-serially collecting logs and used for the failure diagnosis or prediction. When a predetermined number of errors (error codes dependent not on the disk but on the drive) for a command such as read or write, which are supposed to be caused by a factor in the optical disk drive 122, have occurred over a given period of time, it is determined that a failure has occurred. If no command errors are detected, the response time of each command is measured. If the response time delays over a course of time (for example, if the response time is less than 90% of the expected value), it is determined that a sign of a failure is present. Alternatively, the read/write transfer times of the optical disk drive 122 are monitored. In this case, transfer rates which match the specifications of the optical disk drive 122 and media are monitored. If a transfer rate which does not match the specifications is detected, and it can be determined that the medium side has no problem (by determining based on information acquired From the medium whether it is normal), it is determined that a sign of a failure is present.

In addition to the above-described display of feedback information, guidance to self maintenance can also be given (if the user may be able to solve a problem by himself/herself, feedback information to solve the problem is provided). For example, as shown in FIG. 5, when a temperature anomaly is detected, the use environment (high temperature and humidity) is displayed for check. When an anomaly in the laser diode is detected, a message to check contamination and dust around the pickup is displayed. If the eccentricity, the mass eccentricity, or the wobbling detection count is unusual, a message to check the use environment (tilt or vibration), foreign matter in the optical disk drive 122, or a warp of the medium is displayed. Note that the above-described module can be accomplished as software or hardware. A module can be accomplished in software and hardware.

According to the above-described embodiment, it is possible to find and notify a failure or error in the optical disk drive by appropriately combining the above-described predetermined conditions (thresholds) and notification contents (feedback information) corresponding to the conditions. Since the conditions can be changed variously, even when the optical disk drive is apparently operating normally, the user can be notified of a failure sign before the optical disk drive 122 of the computer 10 goes down due to a failure. This increases the chance to avoid any unexpected failure.

All the procedures of control processing of the embodiment can be implemented by software. It is therefore possible to easily obtain the same effect as in the embodiment only by installing a program for executing the procedures in a computer having an optical disk drive with a power saving operation mode via a computer-readable storage medium.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit or the inventions.

What is claimed is:

1. An information processing apparatus comprising:
an optical disk drive;
a power supply module configured to supply power to the information processing apparatus;
an acquisition module configured to start acquisition of status information of said optical disk drive when said power supply module supplies power to the information processing apparatus;
a storage module configured to store feedback information corresponding to each condition predetermined for the status information of said optical disk drive; and
a notification module configured to notify the apparatus of feedback information which is read from said storage module in correspondence with the condition when the status information of said optical disk drive acquired by said acquisition module matches the condition.

2. The apparatus of claim 1, wherein said storage module totals the acquired status information of said optical disk drive and updates the condition based on the totaled status information of said optical disk drive.

3. The apparatus of claim 1, wherein the status information of said optical disk drive is at least one of temperature information of said optical disk drive, eccentricity information of a rotating shaft of said optical disk drive, mass eccentricity information of the rotating shaft of said optical disk drive, wobbling information of a rotating plane of said optical disk drive, and output value information of a laser diode of said optical disk drive.

4. The apparatus of claim 1,
which further comprises a display unit, and
in which when said notification module notifies the apparatus of the feedback information, said display unit displays the feedback information.

5. A health check method used in an information processing apparatus including an optical disk drive and a power supply module configured to supply power to the information processing apparatus, comprising:
predetermining a condition for status information of the optical disk drive and storing feedback information defined for each condition in a storage module;
starting acquisition of the status information of the optical disk drive when the power supply module supplies power to the information processing apparatus; and
notifying the apparatus of the feedback information which is read from the storage module in correspondence with the condition when the acquired status information of the optical disk drive matches the condition.

6. The method of claim 5, wherein the acquired status information of the optical disk drive is collected, and the condition is updated based on the collected status information of the optical disk drive.

7. The method of claim 5, wherein the status information of the optical disk drive is at least one of temperature information of the optical disk drive, eccentricity information of a rotating shaft of the optical disk drive, mass eccentricity information of the rotating shaft of the optical disk drive, wobbling information of a rotating plane of the optical disk drive, and output value information of a laser diode of the optical disk drive.

8. A storage medium which records a program used in an information processing apparatus including an optical disk drive and a power supply module configured to supply power to the information processing apparatus, the program causing a computer to execute:
a storage procedure of determining a condition for status information of the optical disk drive in advance and storing feedback information defined for each condition in a storage module;
an acquisition procedure of starting acquisition of the status information of the optical disk drive when the power supply module supplies power to the information processing apparatus; and
a notification procedure of notifying the apparatus of the feedback information which is read from the storage module in correspondence with the condition when the acquired status information of the optical disk drive matches the condition.
